(19) United States
(12) Patent Application Publication
(10) Pub. No.: US 2014/0198061 A1
(43) Pub. Date: Jul. 17, 2014

(54) ELECTRONIC DEVICE AND METHOD FOR UNLOCKING TOUCH SCREEN OF AN ELECTRONIC DEVICE

(71) Applicant: CHI MEI COMMUNICATION SYSTEMS, INC., New Teipei (TW)

(72) Inventor: SHIH-NAN CHEN, New Taipei (TW)

(73) Assignee: CHI MEI COMMUNICATION SYSTEMS, INC., New Taipei (TW)

(21) Appl. No.: 13/866,030

(22) Filed: Apr. 19, 2013

(30) Foreign Application Priority Data
Jan. 16, 2013 (TW) 102101608

(51) Int. Cl. G06F 3/0488

(52) U.S. Cl. CPC G06F 3/0488
USPC 345/173

(57) ABSTRACT

In a method for unlocking a touch screen of an electronic device, an unlocking interface is displayed on the touch screen. The unlocking interface includes a question input box that reminds a user of the electronic device to input a correct answer to the question input box. The method receives an answer from the question input box inputted by the user, and unlocks the touch screen if the inputted answer is correct.

### BACKGROUND

1. Technical Field

The embodiments of the present disclosure relate to unlocking systems and methods, and more particularly to an electronic device and method for unlocking a touch screen of an electronic device.

2. Description of Related Art

A “slide to unlock” feature is usually used to unlock a touch screen of an electronic device, such as a smart phone, a PDA device, or a tablet computer. However, a wrong touch operation may occur when the “slide to unlock” feature is performed, which may bring some inconveniences to a user of the electronic device.

### BRIEF DESCRIPTION OF THE DRAWINGS

FIG. 1 is a block diagram of one embodiment of an electronic device including a touch screen unlocking system.

FIG. 2 is a block diagram of one embodiment of function modules of the touch screen unlocking system in FIG. 1.

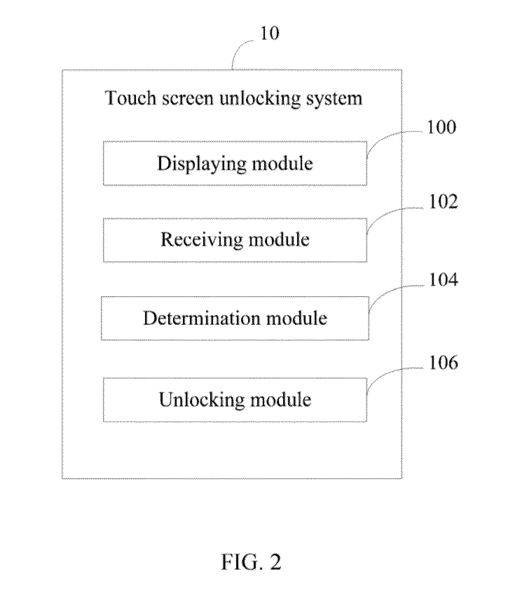

FIG. 3 is a flowchart of one embodiment of a method for unlocking a touch screen of the electronic device in FIG. 1.

FIG. 4 is one exemplary of an unlocking interface for unlocking the touch screen of the electronic device in FIG. 1.

FIG. 5 is another exemplary of the unlocking interface for unlocking the touch screen of the electronic device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

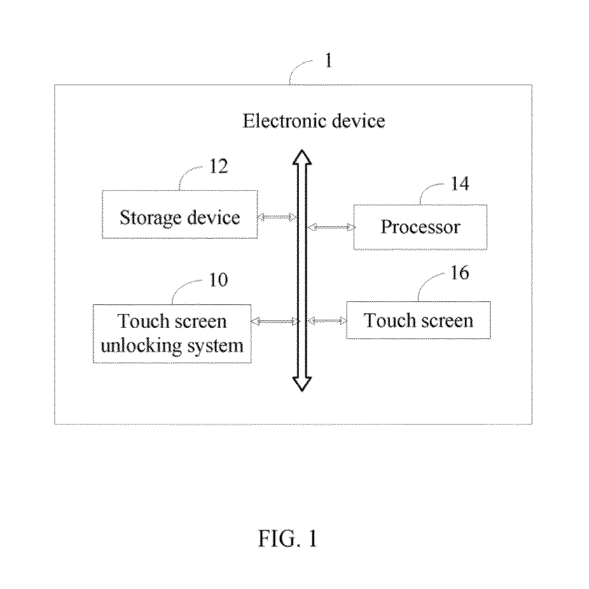

FIG. 1 is a block diagram of one embodiment of an electronic device 1 including a touch screen unlocking system 10. In the embodiment, the electronic device 1 includes a storage device 12, at least one processor 14, and a touch screen 16. The electronic device 1 may be a smart phone, a PDA device, or a tablet computer, for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The touch screen 16 is an input device of the electronic device 1, and displays an unlocking interface for unlocking the touch screen 16.

In one embodiment, the touch screen unlocking system 10 includes a plurality of function modules which include computerized codes or instructions that can be stored in the storage device 12 and executed by the at least one processor 14 to provide a method for unlocking the touch screen 16 of the electronic device 1.

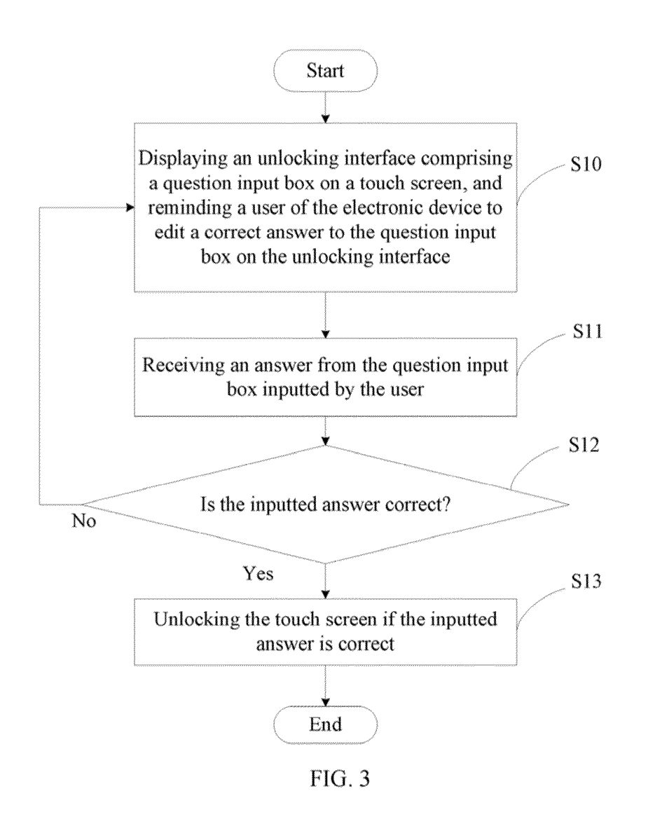

In one embodiment, the touch screen unlocking system 10 may include a displaying module 100, a receiving module 102, a determination module 104, and an unlocking module 106. The modules may comprise computerized codes in the form of one or more programs that are stored in the storage device 12 and executed by the at least one processor 14 to provide functions for implementing the modules. The functions of the function modules 100-106 are illustrated in FIG. 3 and described below.

FIG. 3 illustrates a flowchart of one embodiment of a method for unlocking a touch screen of an electronic device, such as the electronic device 1 of FIG. 1. Depending on the embodiment, additional steps may be added, others removed, and the ordering of the steps may be changed.

In block S10, the displaying module 100 displays a unlocking interface on the touch screen 16 for unlocking the touch screen 16 of the electronic device 1. The unlocking interface includes a question input box. The displaying module 100 reminds a user of the electronic device 1 to input a correct answer in the question input box of the unlocking interface 6. In the embodiment, the question input box is used to receive a mathematic operation inputted by the user, or receive a question for asking a name or an age of the user of the electronic device 1.

The displaying module 100 may lock the touch screen 16 after a predefined time (e.g., 10 seconds) has lapsed, and displays the question input box on the unlocking interface 6 to remind the user to input a correct answer in the question input box.

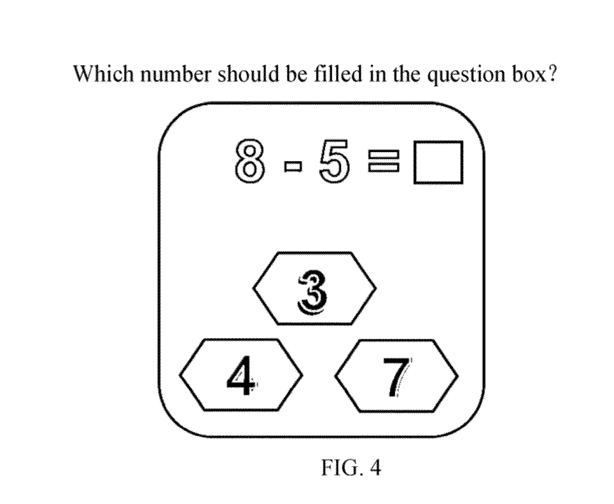

In block S11, the receiving module 102 receives an answer from the question input box inputted by the user of the electronic device 1. In the embodiment, referring to FIG. 4, the inputted answer may be chosen from one answer from a plurality of answers displayed on the unlocking interface.

In block S12, the determination module 104 determines whether the inputted answer is correct. In the embodiment, the determination module 104 compares the inputted answer with a correct answer stored in the storage device 12 to determine whether the inputted answer is correct.

In block S13, the unlocking module 106 unlocks the touch screen 16 if the inputted answer is correct, otherwise, if the inputted answer is incorrect, the flow returns to the block S10.

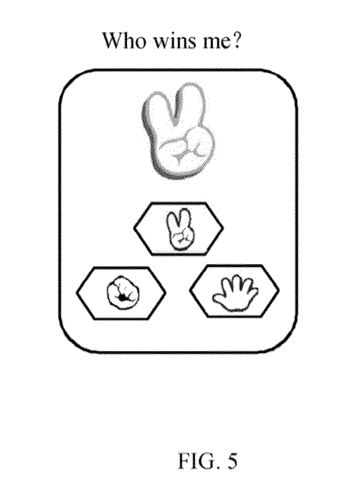

In the embodiment, the displaying module 100 may display a game on the unlocking interface, and the touch screen 16 is unlocked when the user wins the game. Referring to the FIG. 5, the game may be a finger-guessing game, and the touch screen 16 is unlocked when the user wins the finger-guessing game.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. An electronic device, comprising:
a storage device, a touch screen, and at least one processor; and
one or more programs stored in the storage device and executed by the at least one processor, the one or more programs comprising:
a displaying module that displays an unlocking interface comprising a question input box on the touch screen, and reminds a user of the electronic device to input a correct answer to the question input box of the unlocking interface;
a receiving module that receives an answer from the question input box inputted by the user;
a determination module that compares the inputted answer with a corrected answer stored in the storage device to determine whether the inputted answer is correct; and
an unlocking module that unlocks the touch screen if the inputted answer is correct.

2. The electronic device according to claim 1, wherein the question input box is used to receive a mathematic operation inputted by the user, or receive a question asking a name and an age of the user.

3. The electronic device according to claim 1, wherein the inputted answer is chosen from one answer from a plurality of answers displayed on the unlocking interface.

4. The electronic device according to claim 1, wherein the displaying module displays a game on the unlocking interface.

5. The electronic device according to claim 4, wherein the touch screen is unlocked when the user wins the game.

6. A method for unlocking a touch screen of an electronic device, the method comprising:
displaying an unlocking interface comprising a question input box on the touch screen, and reminding a user of the electronic device to edit a correct answer to the question input box of the unlocking interface;
receiving an answer from the question input box inputted by the user;
comparing the inputted answer with a corrected answer stored in a storage device of the electronic device to determine whether the inputted answer is correct; and
unlocking the touch screen if the inputted answer is correct.

7. The method according to claim 6, wherein the question input box is used to receive a mathematics operation inputted by the user, or receive a question for asking a name and an age of the user.

8. The method according to claim 6, wherein the inputted answer is chosen one answer from a plurality of answers displayed on the unlocking interface.

9. The method according to claim 6, the method further comprising a step of displaying a game on the unlocking interface.

10. The method according to claim 9, wherein the touch screen is unlocked when the user wins the game

11. A non-transitory computer-readable storage medium having stored thereon instructions being executed by a processor of an electronic device, causes the electronic device to perform a method for unlocking a touch screen of the electronic device, the method comprising:
displaying an unlocking interface comprising a question input box on the touch screen, and reminding a user of the electronic device to edit a correct answer to the question input box of the unlocking interface;
receiving an answer from the question input box inputted by the user;
comparing the inputted answer with a corrected answer stored in a storage device of the electronic device to determine whether the inputted answer is correct; and
unlocking the touch screen if the inputted answer is correct.

12. The storage medium according to claim 11, wherein the question input box is used to receive a mathematics operation inputted by the user, or receive a question for asking a name and an age of the user.

13. The storage medium according to claim 11, wherein the inputted answer is chosen one answer from a plurality of answers displayed on the unlocking interface.

14. The storage medium according to claim 11, wherein the method further comprises a step of displaying a game on the unlocking interface.

15. The storage medium according to claim 14, wherein the touch screen is unlocked when the user wins the game.
